(19) United States
(12) Patent Application Publication
(10) Pub. No.: US 2018/0361483 A1
(43) Pub. Date: Dec. 20, 2018

(54) Case Trimmer with Sliding Sleeve

(71) Applicant: Larry Goodman, Cerritos, CA (US)

(72) Inventor: Larry Goodman, Cerritos, CA (US)

(21) Appl. No.: 15/628,521

(22) Filed: Jun. 20, 2017

(51) Int. Cl. B23B 5/16; F42B 33/10

(52) U.S. Cl. CPC B23B 5/168; B23B 2215/81; B23B 5/163; F42B 33/10

(57) ABSTRACT

A case mouth trimmer and chamferer includes a clear sliding sleeve covering windows in a barrel portion to capture trimmings. The case mouth chamfer tool may be fixed to a micrometer dial threadedly engaging the barrel. A case adapter bearing is fixed to the barrel to position cases. An end m ill is used trim the case length or a case mouth chamfer tool is adjusted to cut an inside chamfer and the micrometer dial is rotated to adjust the position of the end mill or the case mouth chamfer tool with respect to the case adapter bearing to precisely adjust the amount of material cut from the case. An adjustable cutter holder member slides in a dovetail, is adjusted by advancing and retreating a screw, and is held in place by a set screw. The case adapter bearing is easily changed to chamfer different cases.

### BACKGROUND OF THE INVENTION

The present invention relates to trimming and chamfering ammunition case mouths and in particular to a trimming tool including a clear sleeve for containing trimmings during use.

Ammunition cases are generally the most expensive component of ammunition. Many shooting enthusiasts reuse the cases to save money. While such cases may be capable of multiple uses, some cases, especially expensive high power rifle cases, are stretched in each use. When the cases are stretched, the neck of the case (the portion a bullet is seated in), becomes longer and increases the contact surface with bullet, and affects the release of the bullet when the ammunition is filed. Such changes in the release affect the velocity, and thus the consistency of the bullet at long range.

To address the case stretching, the cases are often trimmed back to the original length. Both manual and electric trimmers are known. Unfortunately, the known electric trimmers require expensive separate components for each size case. U.S. Pat. No. 8,827,607 address these problems by providing a Micrometer Case Trimmer which merely requires a simple guide bearing for various cases, and a micrometer cutting depth adjustment. The '607 patent is incorporated by reference above.

A Micrometer Case Mouth Chamfer Tool including many features of the '607 patent is disclosed in U.S. Pat. No. 9,022,704.

While the '607 and '704 patents provide excellent solutions for case trimming and chaffering, both tools include openings which allow trimmings to escape while the tool is in use. A desire is present for a tooling incorporating the benefits of the '607 and '704 patents but limiting the escape of the trimmings.

### BRIEF SUMMARY OF THE INVENTION

The present invention addresses the above and other needs by providing a case mouth trimmer and chamferer which includes a clear sliding sleeve covering windows in a barrel portion to capture trimmings. The case mouth chamfer tool may be fixed to a micrometer dial threadedly engaging the barrel. A case adapter bearing is fixed to the barrel to position cases. An end m ill is used trim the case length or a case mouth chamfer tool is adjusted to cut an inside chamfer and the micrometer dial is rotated to adjust the position of the end mill or the case mouth chamfer tool with respect to the case adapter bearing to precisely adjust the amount of material cut from the case. An adjustable cutter holder member slides in a dovetail, is adjusted by advancing and retreating a screw, and is held in place by a set screw. The case adapter bearing is easily changed to chamfer different cases.

In accordance with one aspect of the invention, there is provided a case trimming tool which captures case trimmings. A clear sliding sleeve slides over windows in a barrel of the case trimmer to capture the trimmings while allowing viewing of a cutter and the trimmings. The sleeve slides forward to release the trimmings from the case trimmer. On O-ring on the barrel provides resistance to sliding the sleeve to retain the sleeve in place over the windows.

In accordance with another aspect of the invention, there is provided an electric case trimmer assembly having a micrometer cutting adjustment. A first cut is made intentionally leaving the case longer than intended. The case is measured, and the micrometer dial is turned a pre-determined number of lines to precisely adjust the case trimmer to trim the case to the correct length.

In accordance with still another aspect of the invention, there is provided a case chamfering tool. The case chamfering tool includes a base member with a shaft and an adjustable cutter holder member having a dovetail engagement with the base member. The adjustable cutter holder is adjusted to turning a screw having threads engaging the base member and a head cooperating the adjustable cutter holder. The cutter includes three edges and the cutter may be detached and rotated to alternatively use all three of the cutting edges.

In accordance with yet another aspect of the invention, there is provided a method for chamfering cases. The method includes installing a case mouth chamfer tool in a micrometer dial of a case chamfering assembly, installing a case adapter bearing for a selected case type into a barrel of the case chamfering assembly, inserting a case of the selected case type into the case chamfering assembly, adjusting the depth of the cutter to almost touch the case mouth, adjusting the cutter laterally to trim a chamber inside the case mouth, adjusting the position of the cutter to cut a small chamfer in the case mouth, attaching the case chamfering assembly to a drill motor, and insert cases into the trimmer with the drill motor running.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is a side view of a case trimmer and sliding sleeve according to the present invention attached to a drill motor, with the sleeve removed from a barrel of the case trimmer to allow trimmings to be released through windows in the barrel.

FIG. 1B is a side view of the case trimmer and sliding sleeve according to the present invention attached to the drill motor, with the sleeve residing over the barrel of the case trimmer to retain the trimmings.

FIG. 2A is a first side view of the case trimmer according to the present invention.

FIG. 2B is a second side view of the case trimmer according to the present invention.

FIG. 2C is a front view of the case trimmer according to the present invention.

FIG. 2D is a rear view of the case trimmer according to the present invention.

FIG. 3A is a cross-sectional view of the case trimming assembly according to the present invention taken along line 3-3 of FIG. 2B.

FIG. 3B is a cross-sectional view of the case trimming assembly according to the present invention separated into major components taken along line 3-3 of FIG. 2B

FIG. 4 is a side view of the case trimming assembly according to the present invention with a case ready for insertion into the case trimming assembly.

FIG. 5 is a side view of the case trimming assembly according to the present invention with the case in the case trimming assembly.

FIG. 6 is a cross-sectional view of the case trimming assembly according to the present invention with the case in the case trimming assembly taken along line 6-6 of FIG. 5.

FIG. 7 is a side view of the case trimming assembly according to the present invention with the case in the case trimming assembly for a first cut before precision adjustment.

FIG. 8 is a side view of the case trimming assembly according to the present invention with the case in the case trimming assembly for second and latter cuts after precision adjustment.

FIG. 9 is a method according to the present invention.

FIG. 10A shows a left side view of a case mouth chamfer tool according to the present invention.

FIG. 10B shows a top view of the case mouth chamfer tool according to the present invention.

FIG. 10C shows a bottom view of the case mouth chamfer tool according to the present invention.

FIG. 10D shows a front view of the case mouth chamfer tool according to the present invention.

FIG. 10E shows a rear view of the case mouth chamfer tool according to the present invention.

FIG. 10F shows a right side view of the case mouth chamfer tool according to the present invention.

FIG. 11A shows a top view of a base member of the case mouth chamfer tool according to the present invention.

FIG. 11B shows a rear view of the base member of the case mouth chamfer tool according to the present invention.

FIG. 11C shows a front view of the base member of the case mouth chamfer tool according to the present invention.

FIG. 12A shows a top view of an adjustable cutter holder member of the case mouth chamfer tool according to the present invention.

FIG. 12B shows a rear view of the adjustable cutter holder member of the case mouth chamfer tool according to the present invention.

FIG. 12C shows a front view of the adjustable cutter holder member of the case mouth chamfer tool according to the present invention.

FIG. 12D shows a left side view of the adjustable cutter holder member of the case mouth chamfer tool according to the present invention.

FIG. 13A shows a left side view of the adjustable cutter holder member attached to the base member in a first cutting position according to the present invention.

FIG. 13B shows a top view of the adjustable cutter holder member attached to the base member in a first cutting position according to the present invention.

FIG. 14A shows a cross-sectional side view of the adjustable cutter holder member attached to the base member in the first cutting position according to the present invention taken along line 14-14 of FIG. 13B.

FIG. 14B shows a cross-sectional side view of the adjustable cutter holder member attached to the base member in a second cutting position according to the present invention taken along line 14-14 of FIG. 13B.

FIG. 15 shows a case chamfering assembly according to the present invention.

FIG. 16 describes a method for chamfering case mouths according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

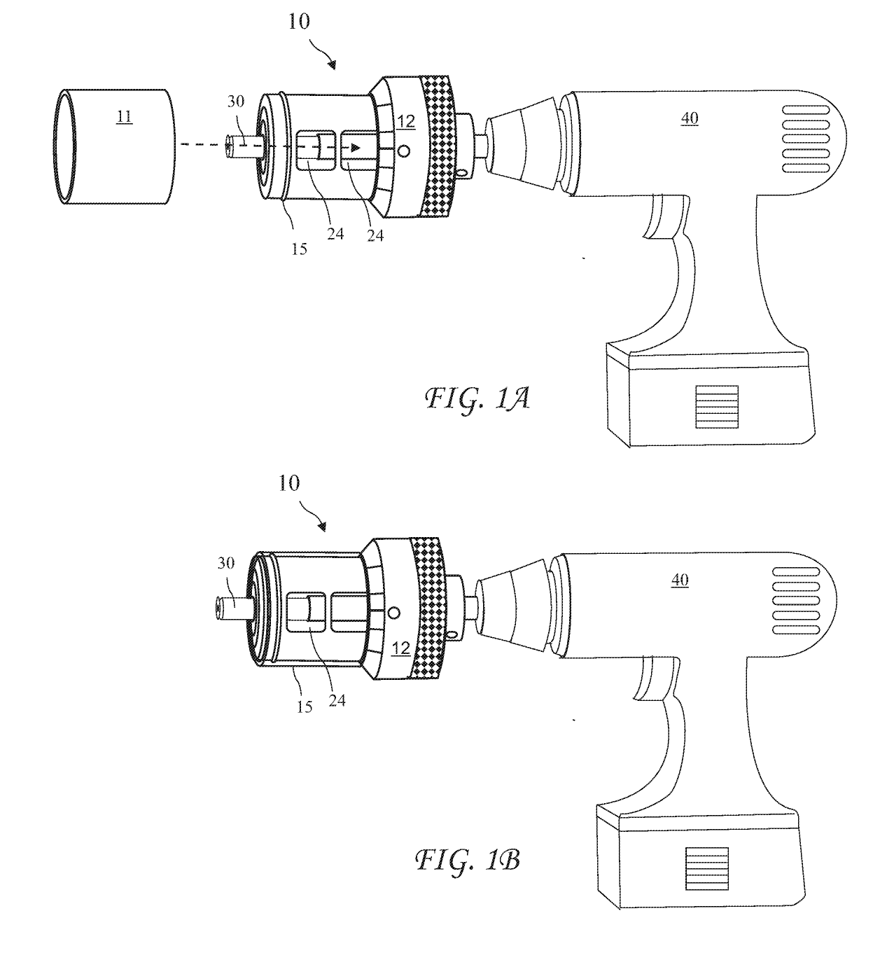

A side view of a case trimmer 10 and clear sliding sleeve 11 according to the present invention attached to a drill moto 40, with the sleeve 11 removed from a barrel 14 of the case trimmer 10 to allow trimmings to be released through windows 24 in the barrel 14 is shown in FIG. 1B, and a side view of the case trimmer 10 and sliding sleeve 11 with the sleeve 11 residing over windows 24 in the barrel 14 of the case trimmer 10 to retain the trimmings is shown in FIG. 1B. The clear sliding sleeve 11 allows a user to view the trimming of case mouths while the sleeve 11 is over the windows 24 while preventing the trimmings from escaping and, for example, to catch trimmings thrown towards a users eyes. The clear sleeve 11 allows the user to view the trapped trimmers, and slide the sleeve 11 forward to release the trimmings when necessary. An O-ring 15 on the barrel 14 provides resistance to sliding the sleeve 11 to retain the sleeve 11 in place over the windows 24.

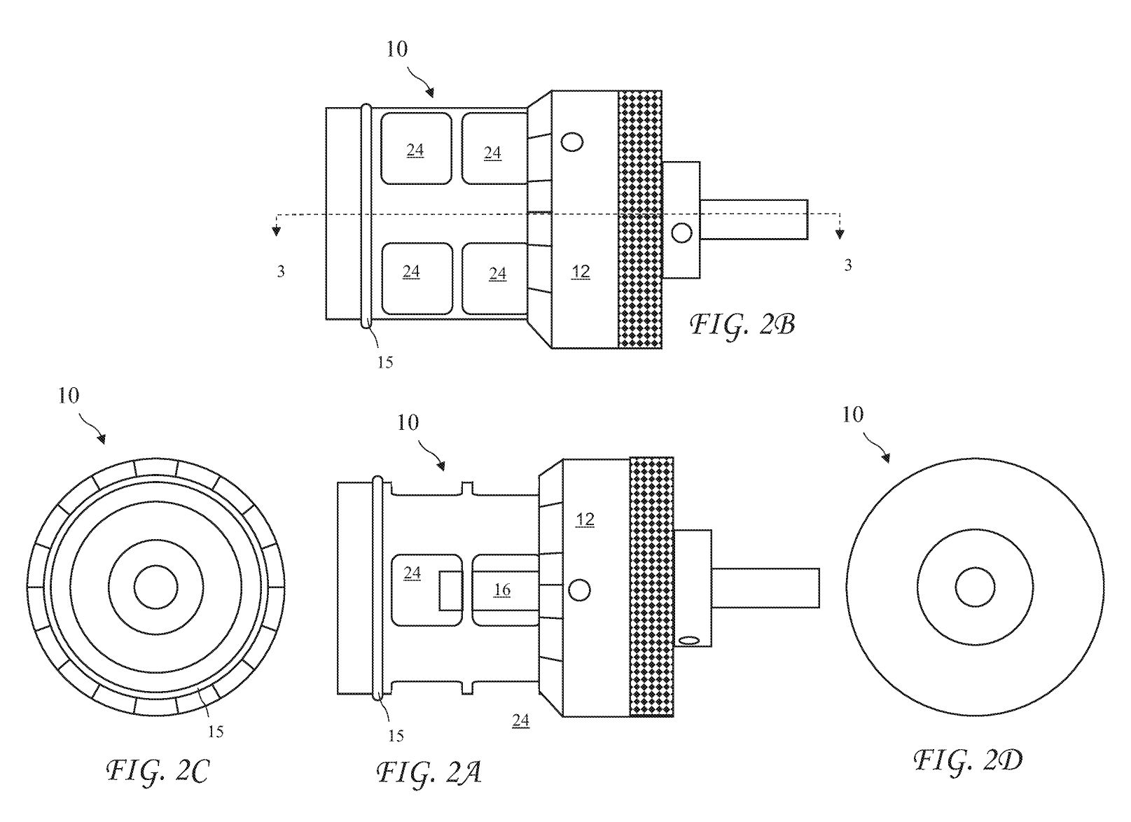

A side view of a case trimming assembly 10 according to the present invention is shown in FIG. 2A, a second side view of the case trimmer 10 is shown in FIG. 2B, a front view of the case trimmer 10 is shown in FIG. 2C, and a rear view of the case trimmer 10 is shown in FIG. 2D. A cutting tool comprising an end mill 16 from trimming cases is seen through the windows 24.

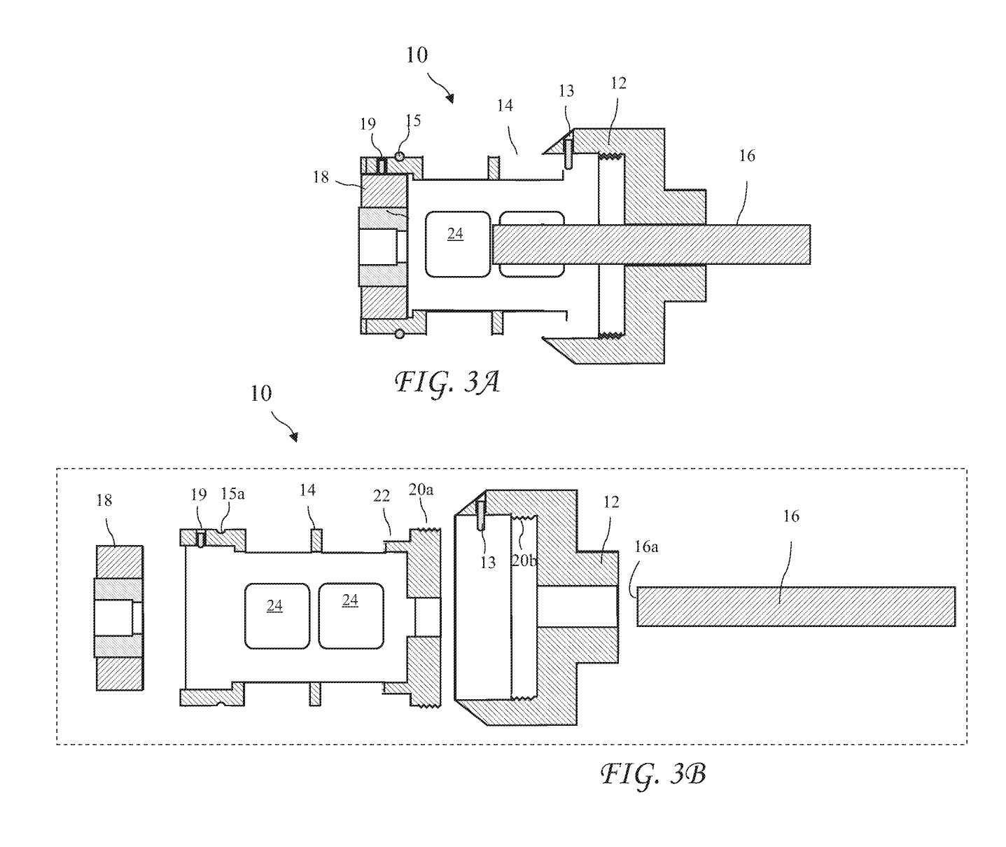

cross-sectional view of the case trimming assembly 10 taken along line 3-3 of FIG. 2B is shown in FIG. 3A, and a cross-sectional view of the case trimming assembly 10 separated into major components taken along line 3-3 of FIG. 2B is shown in FIG. 3B. The case trimming assembly 10 includes a micrometer dial 12 (or end mill holding portion or tool holding portion), a barrel 14 (or case guiding portion), a case adapter bearing 18, and an end mill 16. The end mill 16 is fixedly attached to the micrometer dial 12 using a set screw 17 and the case adapter bearing 18 is fixedly attached to the barrel 14 by a set screw 19. The end mill 16 includes a cutting face 16a for trimming cases. The end mill 16 and case adapter bearing are coaxial with the micrometer dial 12. The O-ring 15 resides in an O-ring groove 15a.

The cutting tool 16 may further include threads to engage threads in the micrometer dial 12, or the micrometer dial 12 may include a collet which is tightened to hold the cutting tool 16.

The barrel 14 threadedly engages the micrometer dial 12 by threads 20a and 20b, and a third set screw 13 engages a notched ring 22 of the barrel 14. The end mill 16 is fixedly attached to the micrometer dial 12 and turning the micrometer dial 12 on the barrel 16 advances and retreats the end mill 16 with respect to the barrel 14. The case adapter bearing 18 includes an outer race 18a fixedly attached to the barrel by the set screw 19 and a rotating inner race 18b having an inner case contour 18c. The inner case contour 18c is configured for one or more cases 30 (see FIG. 4) and limits the distance a case 30 can be inserted into the barrel 14. The set screw 13 serves two purposes. The set screw 13 is tightened against the barrel 14 to fix the position of the micrometer dial for repeated trimming, and during adjustment, the set screw 13 contacts sides of the notched ring 22 to limit adjustment of the micrometer ring 12 on the barrel 14.

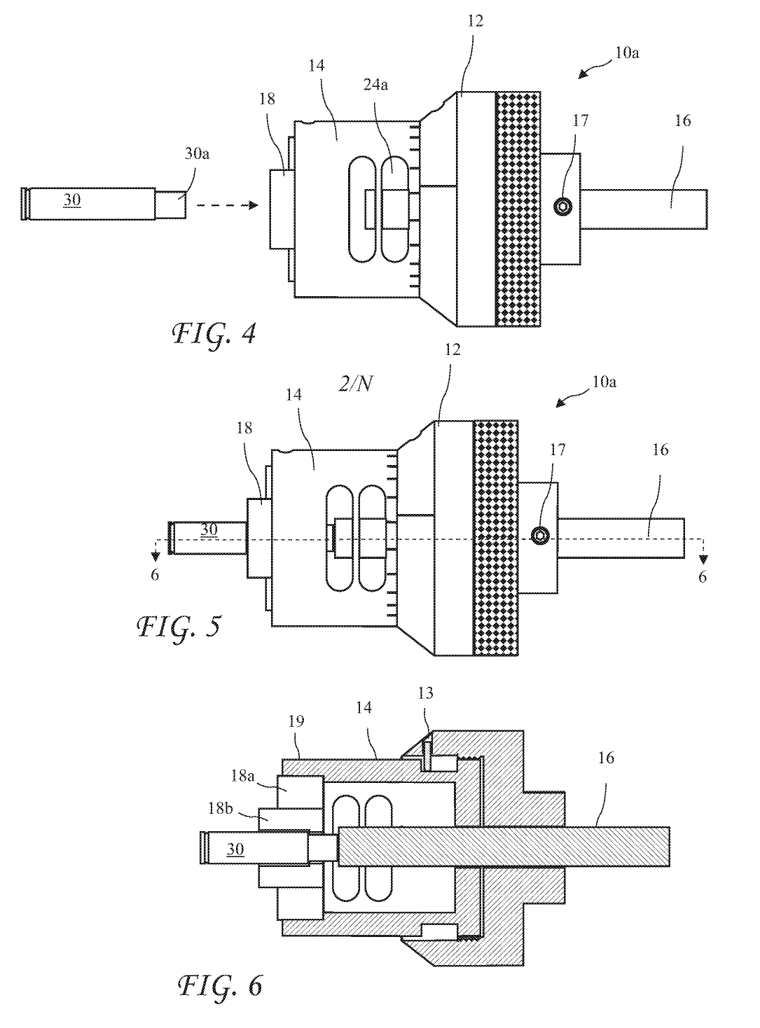

A side view of a second case trimming assembly 10a with a case 30 ready for insertion into the case trimming assembly 10a is shown in FIG. 4, a side view of the case trimming assembly 10a with the case 30 in the case trimming assembly 10a is shown in FIG. 5, and a cross-sectional view of the case trimming assembly 10a with the case 30 in the case trimming assembly 10a taken along line 6-6 of FIG. 5 is shown in FIG. 6. The second case trimming assembly 10a is similar to the case trimming assembly 10 but includes smaller windows 24a. The case trimming assembly 10 preferably includes the following features of the second case trimming assembly 10a

Windows 24a allow viewing the contact of case 30 with the end mill 16 and allows trimmed material to escape from the barrel 14. The case 30 is manually inserted by a user until the case 30 rests against the inner case contour 18c of the case adapter bearing 18. When the case mouth 30a encounters the end mill cutting face 16a before the case 30 is seated against the inner case contour 18c, material is cut from the case mouth 30a until further advance of the case 30 into the barrel is stopped by the inner case contour 18c.

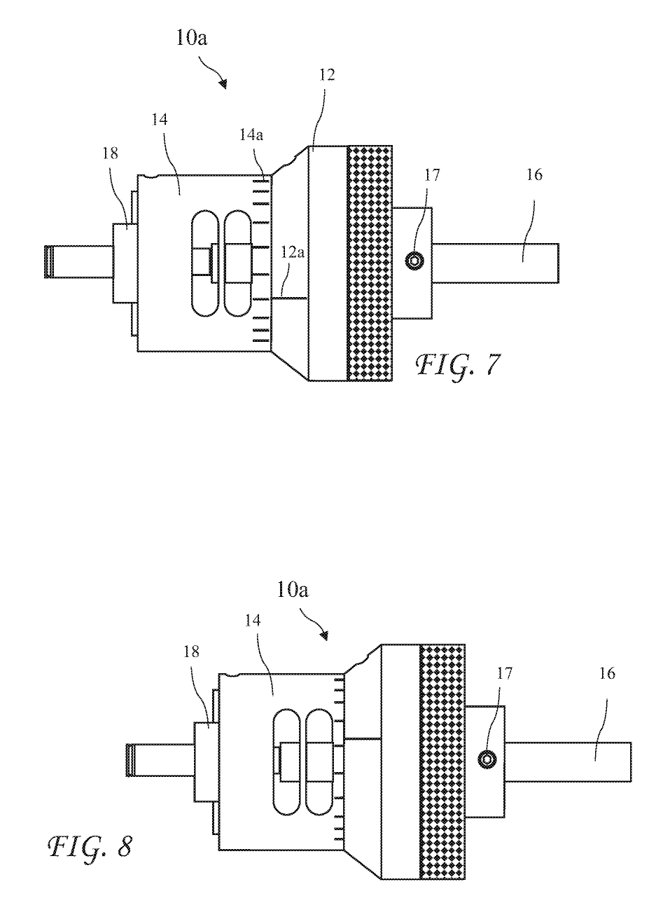

A side view of the case trimming assembly 10a with the case 10a in the case trimming assembly 10a for a first cut before precision adjustment is shown in FIG. 7 and a side view of the case trimming assembly 10a with the case 30 in the case trimming assembly 10a for second and later cuts after precision adjustment is shown in FIG. 8. The first cut is made with the micrometer dial turned counter clockwise as far as possible, but turned back clockwise to align a dial mark 12a with a closest barrel mark 14a. There is preferably a single dial mark 12a and preferably a multiplicity of evenly spaced apart barrel marks 14a. The number of barrel marks may vary, but a relationship between the angular spacing of the barrel marks 14a and the threads 20a and 20b (see FIG. 3) is preferably known and used as a basis for adjusting the micrometer dial 12 on the barrel 14. For example, in a preferred embodiment, turning the micrometer dial 12 to align the dial mark 12a with and adjacent barrel mark 14a, advances or retreats the micrometer dial 12 0.002 inches on the barrel 14.

After making a first cut, the length of the trimmed case 30 is measured, and the micrometer dial is adjusted on the barrel to provide the desired precision cut.

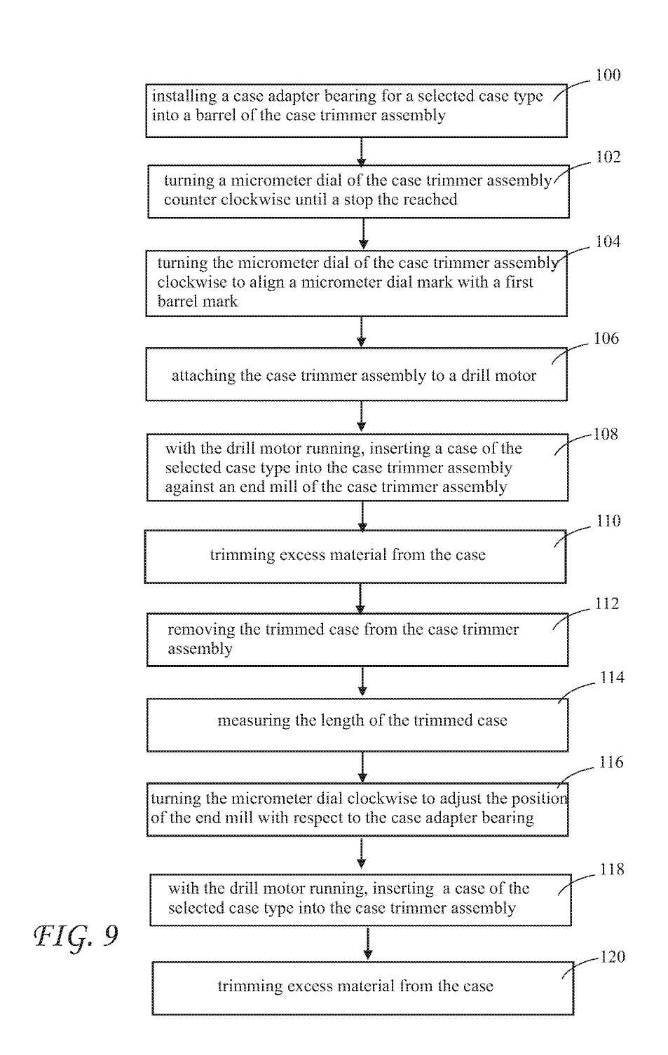

FIG. 9 is a method according to the present invention. The method includes installing a case adapter bearing for a selected case type into a barrel of the case trimmer assembly at step 100, turning a micrometer dial of the case trimmer assembly counter clockwise until a stop is reached at step 102, turning the micrometer dial of the case trimmer assembly clockwise to align a micrometer dial mark with a first barrel mark at step 104, attaching the case trimmer assembly to a drill motor at step 106, with the drill motor running, inserting a case of the selected case type into the case trimmer assembly against an end mill of the case trimmer assembly at step 108, trimming excess material from the case at step 110, removing the trimmed case from the case trimmer assembly at step 112, measuring the length of the trimmed case at step 114, turning the micrometer dial clockwise to adjust the position of the end mill with respect to the case adapter bearing at step 116, with the drill motor running, inserting a case of the selected case type into the case trimmer assembly at step 118, and trimming excess material from the case at step 120.

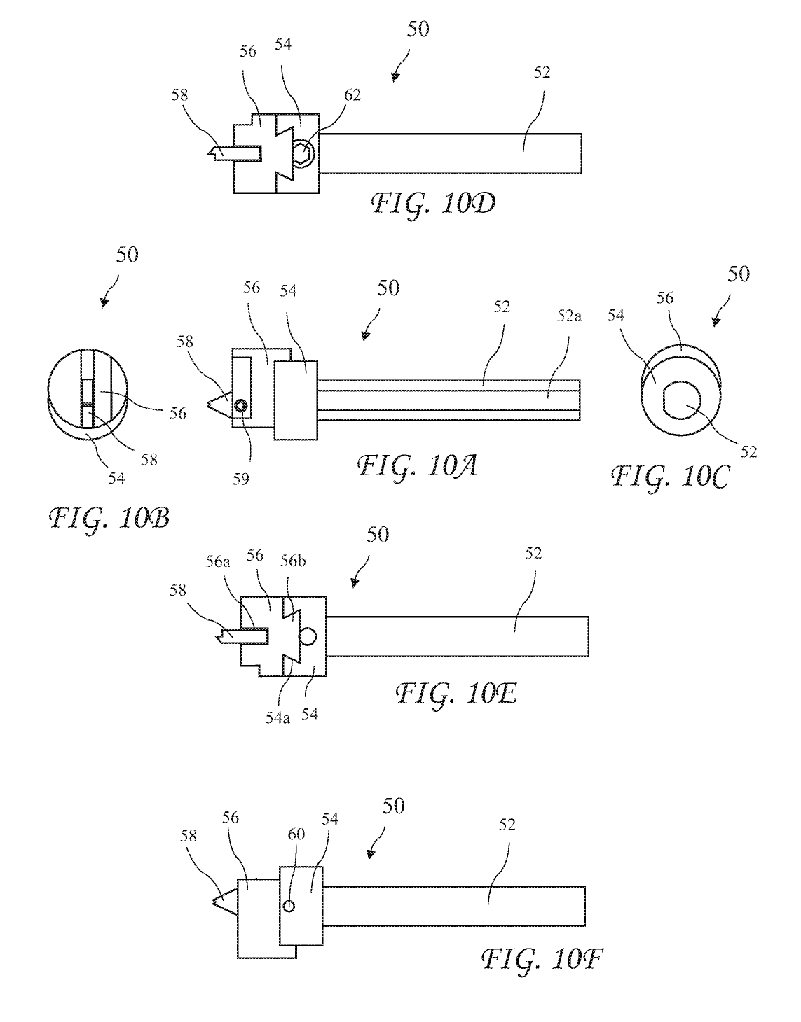

A left side view of a cutting tool comprising a case mouth chamfer tool 50 according to the present invention is shown in FIG. 10A, a top view of the case mouth chamfer tool 50 is shown in FIG. 10B, a bottom view of the case mouth chamfer tool 50 is shown in FIG. 10C, a front view of the case mouth chamfer tool 50 is shown in FIG. 10D, a rear view of the case mouth chamfer tool 50 is shown in FIG. 10E, and a right side view of the case mouth chamfer tool 50 is shown in FIG. 10F. The case mouth chamfer tool 50 holds a cutter 58 used to chamfer mouths of ammunition cases. The cutter is held in a groove 56a in the top of an adjustable cutter holder member 56. A set screw 59 is tightened against the cutter 58 to hold the cutter in the groove 56a. The adjustable cutter holder member 56 includes a dovetail base 56b which slides in a dovetail slot 54a in a base member 54 and is adjusted by turning a screw 62 engaging both the base member 54 and the adjustable cutter holder member 56. The adjustable cutter holder member 56 is held in position after adjustment by a second set screw 60 in the base member 54. The base member 54 includes a shaft 52 having a flat 52a. The case trimmer assembly 10 (see FIG. 1) or 10a (see FIG. 4) may be converted to chamfer case mouths by replacing the end mill 16 with the case mouth chamfer tool 50, held in place by the set screw 17.

A top view of a base member 54 is shown in FIG. 11A, a rear view of the base member 54 is shown in FIG. 11B, and a front view of the base member 54 is shown in FIG. 11C. The base member 54 includes a small female threaded passage 55b and a larger unthreaded passage 55a. The passages 55a and 55b are coaxial and sequential, the passage 55a reaching from the exterior about half way into the base member 54, and passage 55b continuing through the base member 54. The top of the passage 55a opens into the dove tale slot 54a. The base member 54 and shaft 52 share a centerline CL. The dovetail slot 54a is preferably perpendicular to the centerline CL.

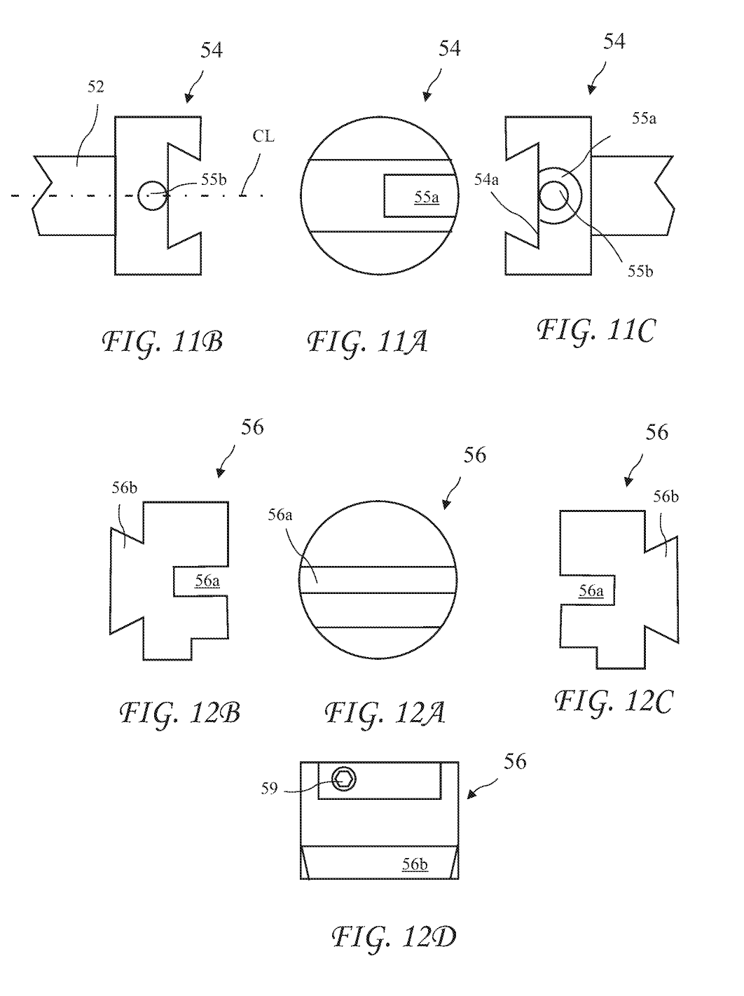

A top view of an adjustable cutter holder member 56 is shown in FIG. 12A, a rear view of the adjustable cutter holder member 56 is shown in FIG. 12B, a front view of the adjustable cutter holder member 56 is shown in FIG. 12C, and a left side view of the adjustable cutter holder member 56 is shown in FIG. 12D.

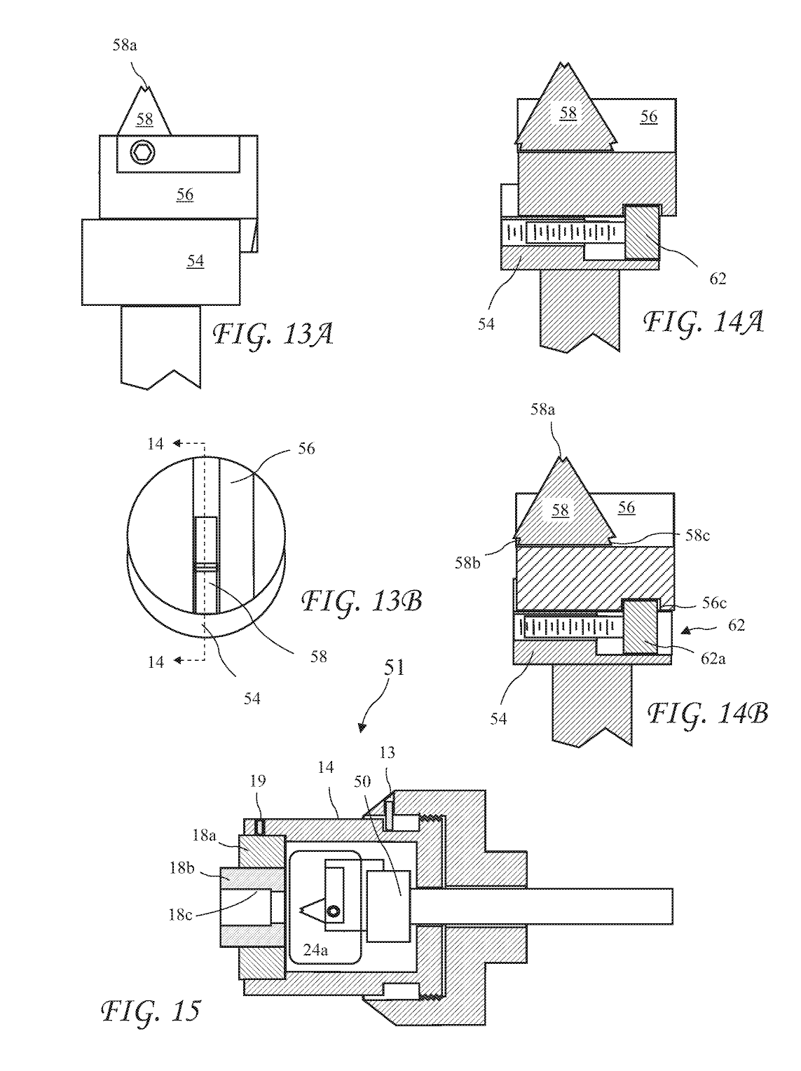

A left side view of the adjustable cutter holder member 56 attached to the base member 54 in a first cutting position is shown in FIG. 13A, a top view of the adjustable cutter holder member 56 attached to the base member 54 in the first cutting position is shown in FIG. 13B, a cross-sectional side view of the adjustable cutter holder member 56 attached to the base member 54 in the first cutting position taken along line 14-14 of FIG. 13B is shown in FIG. 14A, and a cross-sectional side view of the adjustable cutter holder member 56 attached to the base member 54 in a second cutting position taken along line 14-14 of FIG. 13B is shown in FIG. 14B. A screw 62 engages threads in the passage 55b and a head 62a of the screw 62 partially resided in a recess 56c in the bottom of the adjustable cutter holder member 56. Thus turning the screw 62, advances or retreats the screw 62 into the base member 54, and also translates the adjustable cutter holder member 56 with respect to the base member 54, thereby adjusting the position of the cutter 58. The set screw 60 (see FIG. 10F) holds the position of the adjustable cutter holder member 56.

The cutter 58 includes three cutting edges 58a, 58b, and 58c, and the cutter 58 may be detached and rotated to alternatively use all three of the cutting edges. The cutting edges are angled to cut the chamber in the case mouth.

A case chamfering assembly 51 is shown in FIG. 15. The case chamfering assembly 51 is a combination of the case trimming assembly 10 or 10a, replacing the end mill 16 with the case chamfering tool 50. The barrel 14 may include a large window 24a allowing easier lateral adjustment of the cutter 58. When assembled, the windows in the barrel 14 allow access to the screw 68 to laterally adjust the cutter 58 and to the set screw 59 to hold the position of the cutter 58.

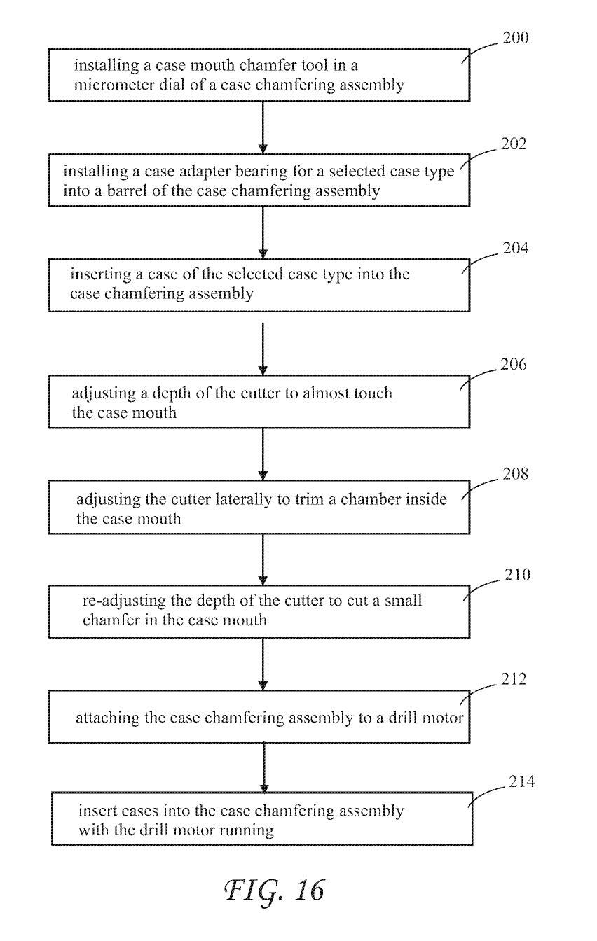

A method for chamfering case mouths according to the present invention is described in FIG. 16. The method includes installing a case mouth chamfer tool in a micrometer dial of a case chamfering assembly at step 200, installing a case adapter bearing for a selected case type into a barrel of the case chamfering assembly at step 202, inserting a case of the selected case type into the case chamfering assembly at step 204, adjusting a depth of the cutter to almost touch the case mouth at step 206, adjusting the cutter laterally to trim a chamber inside the case mouth at step 208, adjusting the position of the cutter to cut a small chamfer in the case mouth at step 210, attaching the case chamfering assembly to a drill motor at step 210, and insert cases into the case chamfering assembly with the drill motor running at step 212. Step 208 may further include turning a barrel of the case chamfering assembly to align windows in the barrel with a cutter lateral adjustment screw and a cutter holding set screw.

While the invention herein disclosed has been described by means of specific embodiments and applications thereof, numerous modifications and variations could be made thereto by those skilled in the art without departing from the scope of the invention set forth in the claims.

1. A case trimming tool, comprising:
a micrometer dial;
a cutting tool held by the micrometer dial;
a forward facing cutting surface on the cutting tool;
a barrel portion threadably cooperating with interior female threads of the micrometer dial to move forward and rearward with respect to the cutting tool, the micrometer dial having a greater diameter than the barrel portion;
windows the through the barrel portion allowing viewing of the forward facing cutting surface engaging a case mouth;
an O-ring groove on an exterior surface of the barrel;
an O-ring residing around the barrel in the O-ring groove;
a sliding sleeve slidable over the barrel and engaging the O-ring to hold a position of the sliding sleeve and positionable against the micrometer dial; and
a case guiding portion attached to the barrel and cooperating with the base member to position the case mouth of a case inserted into the case guiding portion from the cutting tool of the case trimming tool.

2. The case trimming tool of claim 1, wherein the sliding sleeve is a clear sleeve.

3. The case trimming tool of claim 2, wherein cutting tool is an end mill.

4. The case trimming tool of claim 2, wherein cutting tool is a case chamfering tool.

5. The case trimming tool of claim 4, wherein the case chamfering tool includes a triangular chamfering blade having three cutting edges facing the case mouth.

6. The chamfering tool of claim 5, wherein the triangular chamfering blade is adjustable and resides in a slot in an adjustable cutter holder member.

7. A case trimming tool comprising:
a micrometer dial;
a cutting tool fixedly attachable to and detachable from the micrometer dial;
a case adapter bearing having an inner race including an inner case contour configured to limit the advance of a case into the case adapter bearing, wherein different case adapter bearings are provided for different shaped cases;
a barrel, the case adapter bearing fixedly attachable to the barrel and detachable from the barrel, the barrel having a smaller diameter than the micrometer dial and entering the micrometer dial and threadedly cooperating with female threads in an interior of the micrometer dial to adjust a separation of the inner case contour of the case adapter bearing from a cutting face of the cutting tool;
windows the through the barrel portion allowing viewing of the cutting face engaging a case mouth;
an O-ring groove on an exterior surface of the barrel;
an O-ring residing around the barrel in the O-ring groove;
a see through sliding sleeve slidable over the barrel and engaging the O-ring to hold a position of the sliding sleeve resting against the micrometer dial;
a notched circumferential ring on an exterior of the barrel, wherein:
the micrometer dial overlaps the notched circumferential ring;
a radially aligned set screw threadedly engages the micrometer dial reached into the notched circumferential ring; and
the set screw limits the adjustment of the separation of the inner case contour from the cutting face of the cutting tool and fixes the separation of the inner case contour from the cutting face of the cutting tool when tightened against the barrel; and
a multiplicity of uniformly angularly spaced apart barrel marks on the barrel and dial mark on the micrometer dial proximal to the barrel marks, the angular spacing of the barrel marks corresponding to a change in the separation of the inner case contour of the case adapter bearing from a cutting face of an end mill or a case chamfering tool.

8. The case trimming tool of claim 7, wherein cutting tool is the end mill

9. The case trimming tool of claim 7, wherein cutting tool is the case chamfering tool.

10. A method for trimming a case mouth, the method comprising:
installing a case mouth trimming tool into a micrometer dial of a case trimming assembly;
installing a case adapter bearing for a selected case type into a barrel of the case trimming assembly, the barrel adjustably attached to the micrometer dial and having a smaller diameter than the micrometer dial;
sliding a see through sleeve over the barrel and against the micrometer dial to cover windows through the barrel;
inserting a case of the selected case type into the case trimming assembly;
adjusting the micrometer dial of the case trimming assembly to trim a case mouth;
the case mouth trimming tool trimming the case;
removing the trimmed case from the case trimming assembly;
measuring a length of the case;
re-adjusting a depth of the cutter to cut additional material from the case mouth if the case requires additional trimming;
attaching the case trimming assembly to a drill motor;
with the drill motor running, inserting a case of the selected case type into a case adapter bearing of the case trimming assembly against the case mouth trimming tool;
trimming the mouth of the case;
removing the trimmed case from the case trimming assembly;
observing an accumulation of trimmings in the case trimming assembly through the windows in the barrel;
when trimmings have accumulated in the case trimming assembly, sliding the see through sleeve forward to expose the windows in the barrel;
releasing the trimmings from the case trimming assembly;
sliding the see through sleeve back over the barrel to cover the windows through the barrel; and
resuming trimming cases.

11. The method of claim 10, wherein sliding the see through sleeve over the barrel to cover windows through the barrel comprises sliding the see through sleeve over the barrel against resistance from an O-ring residing in an O-ring groove around the barrel.

12. The method of claim 10, further including, before adjusting the micrometer dial of the case trimming assembly to trim the case mouth:
adjusting a position of the case mouth trimming tool in the micrometer dial to almost touch the case mouth comprising:
visually observing, through the windows, the depth of the cutting tool in the case chamfering assembly;
adjusting the depth to position a cutter of the case mouth trimming tool proximal to the case mouth; and
tightening the micrometer dial against a shaft of the case mouth trimming tool to hold the position of the case mouth trimming tool in the micrometer dial.

13. The method of claim 12, wherein tightening the micrometer dial against the shaft of the case mouth trimming tool comprises tightening a set screw.

14. The method of claim 12, wherein tightening the micrometer dial against the shaft of the case mouth trimming tool comprises tightening a threaded fastener reaching through the micrometer dial and against the case mouth trimming tool.

15. (canceled)

16. The case trimming tool of claim 1, wherein the micrometer dial had a forward facing tapered surface and the sleeve engages the forward facing tapered surface to radially center the sleeve on the barrel.

17. The case trimming tool of claim 7, wherein the micrometer dial had a forward facing tapered surface and the sleeve engages the forward facing tapered surface to radially center the sleeve on the barrel.

18. The method of claim 10, wherein sliding the see through sleeve back over the barrel to cover the windows through the barrel the micrometer dial includes sliding the see through sleeve against a forward facing tapered surface of the micrometer dial to center the radially sleeve on the barrel.
